(19) United States
(12) Patent Application Publication
(10) Pub. No.: US 2007/0152929 A1
(43) Pub. Date: Jul. 5, 2007

(54) Device and method for generating synchronous double-frequency signal

(76) Inventors: Chun-Kong Chan, Hsi Chih City (TW); Jeng-Shong Wang, Hsin Chuang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/320,719

(22) Filed: Dec. 30, 2005

(51) Int. Cl. G09G 3/36

(52) U.S. Cl. 345/87

(57) ABSTRACT

A synchronous double-frequency signal generating device includes an integration switching unit controlled by a scan synchronous signal; a first integration unit connected to the integration switching unit for outputting a first integration signal when the scan synchronous signal is at high level; a second integration unit connected to the integration switching unit for outputting a second integration signal when the scan synchronous signal is at low level; an addition unit connected to the first integration unit and the second integration unit for adding up the first integration signal and the second integration signal so as to output a double-frequency modulation signal; and a comparison unit connected to the addition unit for comparing the double-frequency modulation signal with a reference signal so as to output the synchronous double-frequency signal.

### BACKGROUND OF THE INVENTION

1. Field of the Invention

The present invention is related to a device and method for generating synchronous double-frequency signal, and more particularly to a device and method used in a LCD (liquid display) system for generating a synchronous double-frequency signal to the system by adopting a scan synchronous signal in the system so as to eliminate a difference frequency interference generated in the system during PWM (pulse width modulation).

2. Description of Related Art

It can control the inverter by a hardware or a software for lighting or adjusting an illumination variation of the back light source or side light source in a LCD monitor or a LCD panel of a notebook. In market, the display is mainly lighted and beam adjusted in a PWM (pulse width modulation) manner. The principle thereof is that the width of the pulse is controlled to control the inverter power stage to produce incontinous current so as to achieve the purposes of lighting and beam adjusting.

Please refer to FIG. 1 which is a circuit diagram showing a conventional asynchronous PWM beam adjusting inverter. When the user uses a software control to adjust the screen brightness of LCD system (namely, the above described LCD monitor or LCD panel), a microprocessor (not shown) of the LCD system may firstly initiate the PMW unit 10 to control the inverter power unit 12 to light the back light tube 14. During adjusting the brightness of the back light tube 14, the microprocessor may output a brightness control signal to the PWM unit 10, and after comparing and adjusting by the PWM unit 10, a PWM output signal PWMout is generated to the inverter power unit 12. Then, according to the width of the PWM output signal PWMout, the inverter power unit 12 may oscillate for outputting current to light the back light tube 14 in the LCD system, or not oscillate and not output current, so as to achieve the purpose of beam adjusting.

However, using the PWM to execute lighting and beam adjusting is that the current might be full load when the back light tube 14 is adjusted to be “bright” and might be almost no load when the back light tube 14 is adjusted to be “dark”. Therefore, this might cause a lot of low frequency (normally 150˜250 Hz) power source ripples, and when the grounding of LCD system is not easy to be divided, it is extremely easy to cause a difference frequency interference between the PWM operation frequency (normally 150˜250 Hz) and the scan synchronous signals of the LCD system (generally 60 Hz).

In FIG. 1, because synchronous adjusting is not adopted, the phenomenon of difference frequency interference is unavoidable, but if it adopts PLL (phase lock loop), then a synchronous beam adjusting and lighting can be achieved. Please refer to FIG. 2 which is a circuit diagram showing the conventional synchronous PWM beam adjusting using PLL, after the scan synchronous signal of the LCD system is inputted to the PLL unit 11 and is phase locked by the PLL unit 11, it will output a synchronous output signal SYNCout, which is synchronous to the scan synchronous signal, in double frequency (normally 180 Hz˜240 Hz). Then, the synchronous output signal SYNCout, together with a brightness control signal, is inputted to the PWM unit 10, and after an adjusting and comparison by the PWM unit 10, a PWM output signal PWMout is generated to the inverter power unit 12. Finally, the inverter power unit 12 may generate incontinuous current according to the width of the PWM output signal PWMout for achieving the purpose of beam adjusting.

Generally, as considering the problem of human eye's twinkle and the problem of noise, the PWM beam adjusting is operated under a low frequency (150˜250 Hz). However, using PLL in low frequency has the defects of:

a. During low frequency phase lock, the synchronous output signal of the PLL unit 11 may produce more jitters so as to cause the current which passes through the back light tube 14 to be unstable and also cause the back light tube 14 to twinkle.

b. The complexity and cost of the circuits in PLL unit 11 are both high.

### SUMMARY OF THE INVENTION

In view of tthis, the present invention provides a synchronous double-frequency signal generating device used in a LCD system for generating a synchronous double-frequency signal to the system by adopting a scan synchronous signal in the system so as to eliminate a difference frequency interference generated in the system during PWM (pulse width modulation) which also has the advantages of simple circuit and low cost.

The present invention provides a synchronous double-frequency signal generating device including: an integration switching unit for receiving a scan synchronous signal in a LCD system and being controlled by the scan synchronous signal for executing a switching; a first integration unit connected to the integration switching unit for executing an integration operation when the scan synchronous signal is at high level so as to output a first integration signal; a second integration unit connected to the integration switching unit for executing an integration operation when the scan synchronous signal is at low level so as to output a second integration signal; an addition unit connected to the first integration unit and the second integration unit for adding up the first integration signal and the second integration signal so as to output a double-frequency modulation signal; and a comparison unit connected to the addition unit for comparing the double-frequency modulation signal with a reference signal so as to output the synchronous double-frequency signal. The synchronous double-frequency signal is provided to the PWM unit in LCD system for achieving a synchronous lighting or beam adjusting so as to eliminate a difference frequency interference generated in the system during PWM.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a circuit diagram showing a conventional asynchronous PWM beam adjusting inverter;

FIG. 2 is a circuit diagram showing a conventional synchronous PWM beam adjusting using PLL;

FIG. 3 is a block diagram showing the beam adjusting circuit of a synchronous double-frequency signal generating device used in LCD system according to a first embodiment of the present invention;

FIG. 4 is a block diagram showing the beam adjusting circuit of a synchronous double-frequency signal generating device used in LCD system according to a second embodiment of the present invention;

FIG. 5 is a circuit block diagram showing the synchronous double-frequency signal generating device according to a preferred embodiment in the present invention;

FIG. 6 is a circuit block diagram showing the synchronous double-frequency signal generating device according to a preferred embodiment in the present invention; and

FIG. 7 is a schematic view showing the waveform of the circuits in FIG. 6.

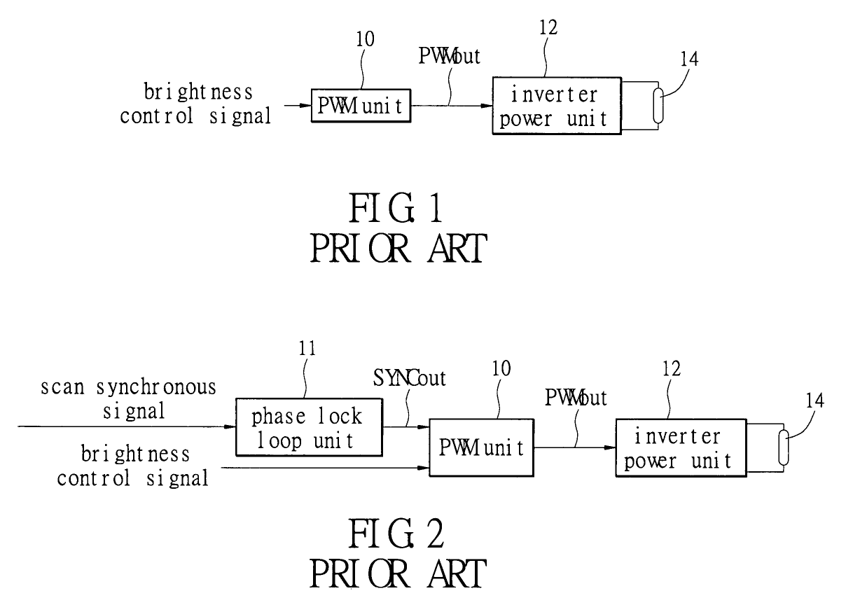

### DETAILED DESCRIPTION OF PREFERRED EMBODIMENTS

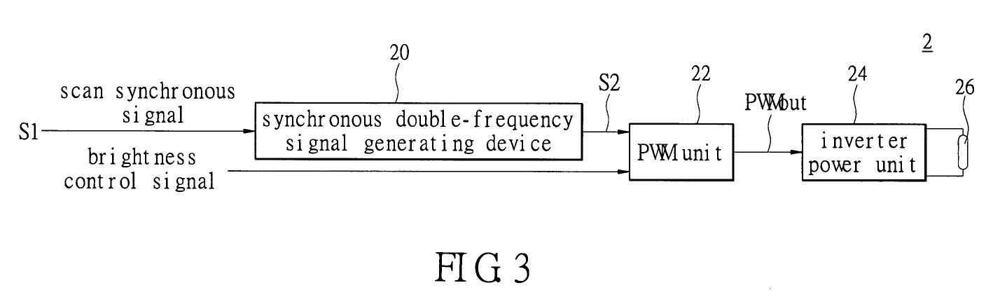

Please refer to FIG. 3 which is a block diagram showing the beam adjusting circuit of a synchronous double-frequency signal generating device used in LCD system according to a first embodiment in the present invention. The LCD system 2 at least includes a synchronous double-frequency signal generating device 20, a PWM unit 22, an inverter power unit 24 and a back light tube 26. The synchronous double-frequency signal generating device 20 may receive a scan synchronous signal S1 in the system so as to output a synchronous double-frequency signal S2, which is synchronous to the scan synchronous signal S1. The synchronous double-frequency signal S2, together with a brightness control signal, is inputted to the PWM unit 22. After an adjusting and comparison by the PWM unit 10, a PWM output signal PWMout is generated to the inverter power unit 24. The inverter power unit 24 may generate incontinuous current according to the width of the PWM output signal PWMout for achieving the purpose of beam adjusting the back light tube 26. In the first embodiment, the scan synchronous signal S1 in the system is a vertical synchronous signal.

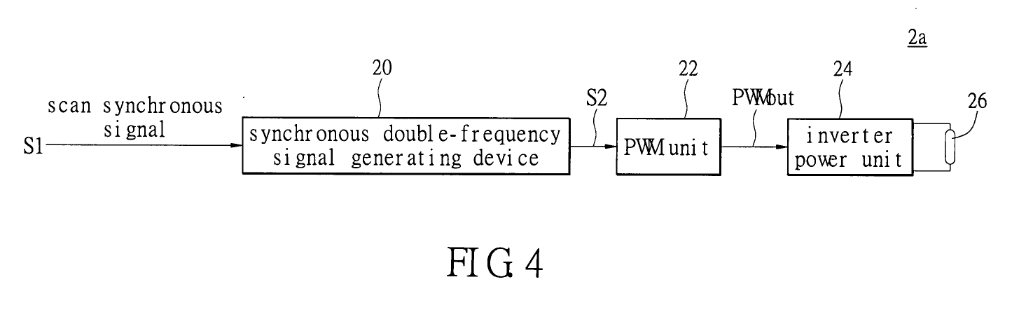

Please refer to FIG. 4 which is a block diagram showing the lighting circuit of a synchronous double-frequency signal generating device used in LCD system according to a second embodiment in the present invention. Comparing with the first embodiment, in the second embodiment, the synchronous double-frequency signal generating device 20 is used to be the working frequency for lighting the CRT and is synchronous to the received scan synchronous signal S1, wherein the scan synchronous signal S1 in the system is a horizontal synchronous signal. At the same time, because the second embodiment is used for lighting, it is unnecessary to receive the brightness control signal.

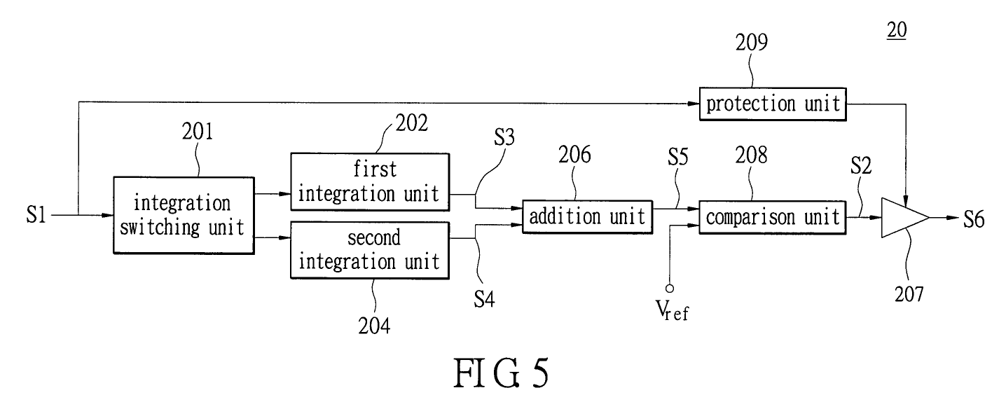

Please refer to FIG. 5 which is a circuit block diagram showing the synchronous double-frequency signal generating device according to a preferred embodiment in the present invention. The synchronous double-frequency signal generating device 20 includes: an integration switching unit 201 for receiving a scan synchronous signal S1 and being controlled by the high/low level of the scan synchronous signal S1 for executing a switching; a first integration unit 202 connected to the integration switching unit 201 for executing an integration operation when the scan synchronous signal S1 is at high level so as to output a first integration signal S3; a second integration unit 204 connected to the integration switching unit 201 for executing an integration operation when the scan synchronous signal S1 is at low level so as to output a second integration signal S4; an addition unit 206 connected to the first integration unit 202 and the second integration unit 204 for adding the first integration signal S3 to the second integration signal S4 so as to output a double-frequency modulation signal S5; and a comparison unit 208 connected to the addition unit 206 for comparing the double-frequency modulation signal S5 with a reference signal Vref so as to output the synchronous double-frequency signal S2.

Further refer to FIG. 5, the synchronous double-frequency signal generating device 20 further includes an inverter 207 connected to the comparison unit 208. The. inverter 207 may receive the double-frequency modulation signal S5 in order to output an inverse synchronous double-frequency signal S6. A protection unit 209 connected to the integration switching unit 201 and the inverter 207 is also included for stopping the synchronous double-frequency signal S2 when the scan synchronous signal S1 is stopped so that the error of the synchronous double-frequency signal S2 and the inverse synchronous double-frequency signal S6 caused by the electromagnetic interference of the peripheral circuits can be avoided when the scan synchronous signal S1 is still not be inputted.

In the synchronous double-frequency signal generating device 20, the first integration unit 202 is constituted by a resistor serially connecting with a capacitor, the second integration unit 204 is constituted by a resistor serially connecting with a capacitor, the integration switching unit 201 is constituted by connecting at least a MOS transistor, and the frequency of the synchronous double-frequency signal S2 is two times the frequency of the scan synchronous signal S1.

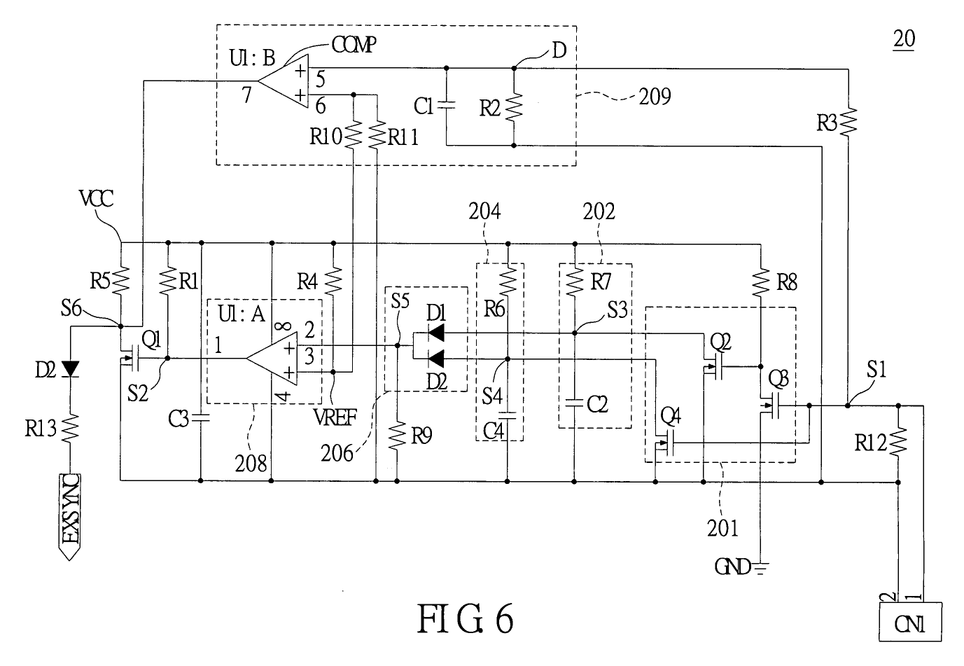

Coordinating with FIG. 5, please refer to FIG. 6 which is a circuit block diagram showing the synchronous double-frequency signal generating device according to a preferred embodiment in the present invention. In FIG. 6, the integration switching unit 201 is constituted by MOS transistors Q2, Q3, Q4, the first integration unit 202 is constituted by a resistor R7 serially connecting with a capacitor C2, the second integration unit 204 is constituted by a resistor R6 serially connecting with a capacitor C4, and the addition unit 206 is constituted by two diodes D1, D2.

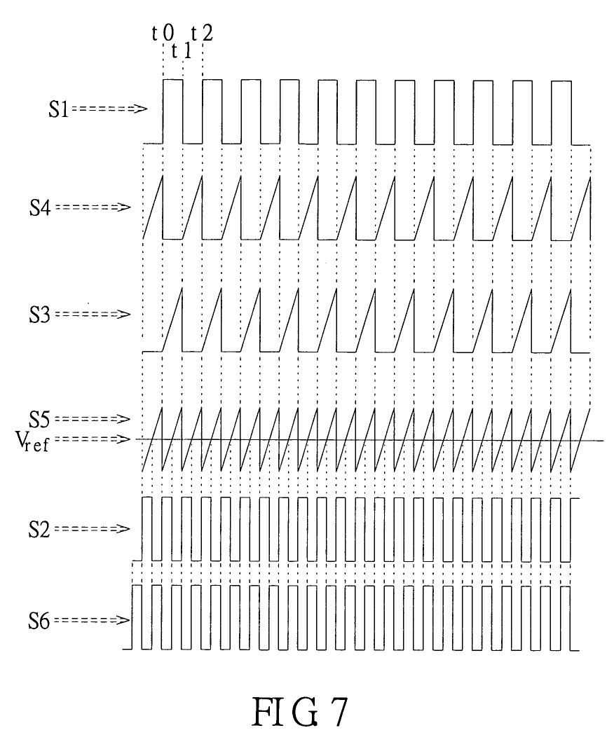

FIG. 7 is a schematic view showing the waveform of the circuits in FIG. 6. Referring to FIGS. 6 and 7, the working principle of the circuits in the synchronous double-frequency generating device 20 is described as followed. The integration switching unit 201 is controlled by a scan synchronous signal S1 having a fixed frequency square wave. During t0 to t1, the scan synchronous signal S1 is at high level, and in the integration unit 201, the MOS transistor Q3 is conducted (ON), the MOS transistor Q2 is cut-off (OFF), and the MOS transistor Q4 is conducted (ON). At this time, voltage source VCC will charge the capacitor C2 via the resistor R7 in the first integration unit 202 and the first integration signal S3 is acquired on the capacitor C2. Furthermore, because the MOS transistor Q4 is conducted (ON), the capacitor C4 in the second integration unit 204 will execute a discharging such that the second integration signal S4 on the capacitor C4 may have a zero potential.

During t1 to t2, the scan synchronous signal S1 is at low level, and in the integration unit 201, the MOS transistor Q3 is cut-off (OFF), the MOS transistor Q2 is conducted (ON), and the MOS transistor Q4 is cut-off (OFF). At this time, voltage source VCC will charge the capacitor C4 via the resistor R6 in the second integration unit 204 and the second integration signal S4 is acquired on the capacitor C4. Moreover, because the MOS transistor Q2 is conducted (ON), the capacitor C2 in the second integration unit 202 will execute a discharging such that the first integration signal S3 on the capacitor C2 may have a zero potential.

The addition unit 206 receives the first integration signal S3 and the second integration signal S4 and outputs the double-frequency modulation signal S5, whose frequency is two times the frequency of the first integration signal S3 and the second integration signal S4. The comparison unit 208 is a voltage comparator and will compare the double-frequency modulation signal S5 with the reference voltage Vref for outputting the synchronous double-frequency signal S2, which is synchronous to and two times the scan synchronous signal S1, wherein when the double-frequency modulation signal S5 is larger than the reference voltage Vref, the synchronous double-frequency signal S2 is at a negative potential, on the other hand, when the double-frequency modulation signal S5 is smaller than the reference voltage Vref, the synchronous double-frequency signal S2 is at a positive potential.

Again, refer to FIG. 6, the synchronous double-frequency signal S2 can further pass through an inverter 207 for producing an inverse synchronous double-frequency signal S6. After passing through a rectify diode D2, the inverse synchronous double-frequency signal S6 is provided to an oscillator (not shown) in the PWM unit 22. Moreover, when there is no scan synchronous signal S1 produced in the system, the protection unit 209 constituted by connecting the comparator COMP with the resistors R2, R10, R11 and the capacitor C1 will provide a negative potential to the inverter 207 for forcing a zero output (namely, low level (LOW)).

In the aforesaid, the present invention provides a synchronous double-frequency signal generating device used in the LCD system which adopts a scan synchronous signal in the system to produce a synchronous double-frequency signal so as to light or beam adjust the LCD system. At the same time, the present invention also can eliminate the difference frequency interference produced by pulse width modulation in the system and own the advantages of simple circuit and low cost. Furthermore, the present invention also can acquire a better synchronous state without jitter.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A synchronous double-frequency signal generating device used in a LCD (liquid display) system for receiving a scan synchronous signal in the system and outputting a synchronous double-frequency signal to the system so as to achieve a synchronous beam adjusting and eliminate a difference frequency interference generated in the system during PWM (pulse width modulation), the device comprising:
an integration switching unit controlled by the scan synchronous signal for executing a switching;
a first integration unit connected to the integration switching unit for executing an integration operation when the scan synchronous signal is at high level so as to output a first integration signal;
a second integration unit connected to the integration switching unit for executing an integration operation when the scan synchronous signal is at low level so as to output a second integration signal;
an addition unit connected to the first integration unit and the second integration unit for adding up the first integration signal and the second integration signal so as to output a double-frequency modulation signal; and
a comparison unit connected to the addition unit for comparing the double-frequency modulation signal with a reference signal so as to output the synchronous double-frequency signal.

2. The device as claimed in claim 1, further comprising an inverter connected to the comparison unit for receiving the synchronous double-frequency signal so as to output an inverse synchronous double-frequency signal.

3. The device as claimed in claim 2, further comprising a protection unit connected to the integration switching unit and the inverter for stopping the output of the inverse synchronous double-frequency signal when the scan synchronous signal is stopped.

4. The device as claimed in claim 1, wherein the first integration unit comprises a resistor and a capacitor, and the resistor serially connects with the capacitor.

5. The device as claimed in claim 1, wherein the second integration unit comprises a resistor and a capacitor, and the resistor serially connects with the capacitor.

6. The device as claimed in claim 1, wherein the integration switching unit comprises at least a MOS transistor.

7. The device as claimed in claim 1, wherein the frequency of the synchronous double-frequency signal is two times the frequency of the scan synchronous signal.

8. A method of generating a synchronous double-frequency signal used in a LCD system for processing a scan synchronous signal in the system to generate a synchronous double-frequency signal so as to achieve a synchronous beam adjusting and eliminate a difference frequency interference generated in the system during PWM (pulse width modulation), the method comprising steps of:
executing a first integration operation when the scan synchronous signal is at high level;
executing a second integration operation when the scan synchronous signal is at low level;
adding up results of the first and the second integration operations for generating an integration signal having a frequency higher than that of the scan synchronous signal; and
comparing the integration signal with a reference signal for generating the synchronous double-frequency signal.

9. The method as claimed in claim 8, wherein when executing the second integration operation, the scan synchronous signal at low level is inversed to the high level previously and than the second integration operation is started.

10. The method as claimed in claim 8, wherein before the scan synchronous signal is generated, the synchronous double-frequency signal is controlled by a protection unit for stopping the output.

11. The method as claimed in claim 8, wherein when executing the first integration operation, the first integration operation is achieved by charging a capacitor by a voltage source via a resistor.

12. The method as claimed in claim 8, wherein when executing the second integration operation, the second integration operation is achieved by charging a capacitor by a voltage source via a resistor.
